(19) United States
(12) Patent Application Publication
(10) Pub. No.: US 2003/0179882 A1
(43) Pub. Date: Sep. 25, 2003

(54) Variable-length/fixed-length data conversion method and apparatus

(75) Inventor: Seiho Itano, Tokyo (JP)

Correspondence Address: MCGINN & GIBB, PLLC, 8321 OLD COURTHOUSE ROAD, SUITE 200, VIENNA, VA, 22182-3817, US

(73) Assignee: Allied Telesis Kabushiki Kaisha, Tokyo (JP)

(21) Appl. No.: 10/307,400

(22) Filed: Dec. 2, 2002

(30) Foreign Application Priority Data
Mar. 25, 2002 (WO) PCT/JP02/02832
Apr. 30, 2002 (WO) PCT/JP02/04314

(51) Int. Cl. H04L 9/00

(52) U.S. Cl. 380/28

(57) ABSTRACT

A data conversion technique allows efficient processing of fixed-length data even when a remainder is produced by dividing the variable-length by a predetermined fixed length. A remainder data length is produced by dividing variable-length data in units of a predetermined fixed length and an added data length is determined by subtracting the remainder data length from the predetermined fixed length. By adding addition data including the remainder data length to the variable-length data, data allowing fixed-length processing is obtained.

### BACKGROUND OF THE INVENTION

1. Field of the Invention

The present invention relates to data conversion techniques between variable-length data and fixed-length data and, in particular, relates to a conversion method and apparatus in a system including fixed-length processing of variable-length data, and further relates to an encryption/decryption technique using the conversion method and apparatus for use in a media converter that converts from one type of transmission media to another.

2. Description of the Related Art There has been a lot of talk recently about FTTH (Fiber To The Home) allowing high-speed transmission of multimedia data such as music, moving picture, and medical data by the installation of optical fiber directly to the home or office. In an era of FTTH, a media converter is an indispensable communication device to connect a fiber-optic line to a computer in the home or office.

In general, a media converter has a pair of ports that are to be connected to a fiber-optic cable and a UTP cable, respectively. For each of the ports, a physical-layer device is provided, which supports MII (Media Independent Interface) conforming to IEEE802.3 standards. In addition, since a media converter converts from one type of transmission media to another, it usually has a missing-link function such that, in case of disconnection in one link, the other link is automatically disconnected.

Such a media converter allows long distance optical transmission using a fiber-optic cable. For example, one port of the media converter is connected to a management switch of a LAN (Local Area Network) through a UTP (Unshielded Twisted Pair) cable and the other port is connected to the fiber-optic cable. At the other end of the connection, similarly, a media converter is used to convert from a fiber-optic cable to a UTP cable, which is connected to a management switch. In this manner, LANs can form a single domain using an optical communication line.

In such a communication system, the security of LANs and optical communication line is one of important issues. To ensure the security, it can be considered that data encryption/decryption function is incorporated in a media converter.

However, when n-byte data is encrypted using DES (Data Encryption Standard) that is one of encryption techniques, it is required that the n-byte data be divided in units of 8 bytes before inputting to the DES. In this case where the n-byte data is divided by 8, remainders less than 8 bytes may be produced depending on the value of n. Accordingly, there is required a data extension technique of extending the remainder to a length of 8 bytes that is acceptable to input of DES.

There have been proposed various techniques of converting variable-length data to fixed-length data. For example, Japanese Patent Application Publication No. 08-030437 discloses a computer, which performs parallel processing using a plurality of arithmetic processors to divide the variable-length data into optimum fixed-length data.

Further, Japanese Patent Application Publication No. 2001-332978 discloses a data stream conversion method, which produces fixed-length data by transferring the variable-length data to a register and sequentially outputting data in units of a fixed bit length from the register when the amount of data stored in the register exceeds a predetermined number of bits. The data finally left in the register is combined with subsequently input data and is output as included in next fixed-length data.

In the computer disclosed in the Japanese Patent Application Publication No. 08-030437, however, the length of variable-length data is set to an integral multiple of that of fixed-length data and therefore it is assumed that no remainder is produced when dividing the variable-length data.

In contrast, the Japanese Patent Application Publication No. 2001-332978 refers to the processing of data (remainder) left in the register after the variable-length data has been divided and output in units of the fixed-length data. However, this conventional conversion method is designed to output the variable-length data as a stream of fixed-length data and is without processing each fixed-length data produced by dividing the variable-length data as one set. Accordingly, it is understood that the data finally left in the register can be combined with the subsequently input data to output it as included in the next fixed-length data.

### SUMMARY OF THE INVENTION

An object of the present invention is to provide a novel data conversion method of dividing variable-length data into fixed-length data to be processed.

Another object of the present invention is to provide a variable-length/fixed-length data conversion method and apparatus allowing efficient processing of fixed-length data even when a remainder is produced by dividing the variable-length by a predetermined fixed length.

Further another object of the present invention is to provide a variable-length/fixed-length data conversion method and apparatus allowing data obtained by fixed-length processing of variable-length data to be readily converted back into original variable data.

Still another object of the present invention is to provide a media converter and an encryption/decryption method and apparatus of converting variable-length data into fixed-length data allowing encryption processing.

According to the present invention, a data conversion method for fixed-length processing of variable-length data, includes the steps of: dividing a length of the variable-length data by a predetermined fixed length to produce a remainder data length; subtracting the remainder data length from the predetermined fixed length to produce an added data length; generating addition data including reference data that is used to determine the added data length; and adding the addition data to the variable-length data to produce extended data that allows the fixed-length processing.

The reference data is preferably placed at a tail end of the extended data. The reference data may be indicative of the remainder data length.

According to anther aspect of the present invention, a data conversion method for use in a system composed of a transmitting side and a receiving side, includes the steps of: the transmitting side dividing a length of the variable-length data by a predetermined fixed length to produce a remainder data length; subtracting the remainder data length from the predetermined fixed length to produce an added data length; generating addition data including reference data that is used to determine the added data length; adding the addition data to the variable-length data to produce extended data having the reference data placed at a predetermined position of the extended data; and performing the fixed-length processing of the extended data to produce transmission data to be transmit to the receiving side, and the receiving side receiving the transmission data from the transmitting side; performing reversed fixed-length processing of the received transmission data by reversing the fixed-length processing of the extended data to produce reception data; reading the reference data from the predetermined position of the reception data to determine the added data length; and removing data corresponding to the added data length from the reception data to reproduce original variable-length data.

The fixed-length processing may be encryption processing and the reversed fixed-length processing may be decryption processing corresponding to the encryption processing.

According to an embodiment of the present invention, a media converter for converting from one type of transmission media to another, includes: a first physical-layer interface to a first transmission medium; a second physical-layer interface to a second transmission medium; and an encryption section connected between the first and second physical-layer interfaces, for converting variable-length data received from the first physical-layer interface into fixed-length data of a predetermined fixed length to encrypt it and output encrypted data to the second physical-layer interface. The encryption section includes: a calculator for dividing a length of the variable-length data by the predetermined fixed length to produce a remainder data length and subtracting the remainder data length from the predetermined fixed length to produce an added data length; a data adder for generating addition data including reference data that is used to determine the added data length and adding the addition data to the variable-length data to produce extended data allowing encryption processing, wherein the reference data is placed at a predetermined position of addition data; and an encryption processor for encrypting the extended data to produce the encrypted data.

The media converter may further include: a decryption section connected between the first and second physical-layer interfaces, for decrypting encrypted data received from the second physical-layer interface to produce variable-length data to output it to the first physical-layer interface, wherein the decryption section includes: a decryption processor for decrypting the encrypted data to produce reception data; a calculator for reading reference data from the predetermined position of the reception data to determine an added data length; and an added data remover for removing data corresponding to the added data length from the reception data to reproduce original variable-length data.

According to another embodiment of the present invention, an encryption method in a media converter for converting from one type of transmission media to another, includes the steps of: dividing a length of the variable-length data by a predetermined fixed length to produce a remainder data length; subtracting the remainder data length from the predetermined fixed length to produce an added data length; generating addition data including reference data that is used to determine the added data length; adding the addition data to the variable-length data to produce extended data that allows the fixed-length processing; and encrypting the extended data in units of the predetermined fixed length.

According to still another embodiment of the present invention, a decryption method for decrypting encrypted data produced by the above encryption method, includes the steps of: receiving the encrypted data; decrypting the encrypted data to produce reception data; reading the reference data from the predetermined position of the reception data to determine the added data length; and removing data corresponding to the added data length from the reception data to reproduce original variable-length data.

As described above, according to the present invention, a remainder data length is produced by dividing variable-length data in units of a predetermined fixed length and an added data length is determined by subtracting the remainder data length from the predetermined fixed length. By adding addition data including reference data used to determined an added data length to the variable-length data, data allowing fixed-length processing is obtained. Accordingly, only addition of a small amount of addition data allows fixed-length processing of variable-length data.

In addition, by reading the reference data from the extended data, the added data length included in the extended data can be determined. Accordingly, easy reproduction of original variable-length data is allowed by deleting the addition data from the extended data.

Therefore, data conversion according to the present invention is a very effective technique in the case where variable-length data is subjected to data processing where only fixed-length input is acceptable.

### BRIEF DESCRIPTION OF THE DRAWINGS

FIG. 1 is a schematic block diagram showing a data processing system employing a variable-length/fixed-length data conversion method according to an embodiment of the present invention;

FIG. 2 is a flow chart showing an example of extension data addition operation according to the embodiment of the present invention;

FIG. 3 is a format diagram for explaining generation of extension data;

FIG. 4 is a flow chart showing an example of extension data removal operation according to the embodiment of the present invention;

FIG. 5 is a schematic diagram of a media converter according to the embodiment of the present invention;

FIG. 6 is a diagram showing a flow of encryption/decryption in the transceiver as shown in FIG. 5; and

FIG. 7 is a schematic block diagram showing a media converter to which an encryption/decryption method according to the present invention is applied.

### DESCRIPTION OF THE PREFERRED EMBODIMENTS

1. System Components

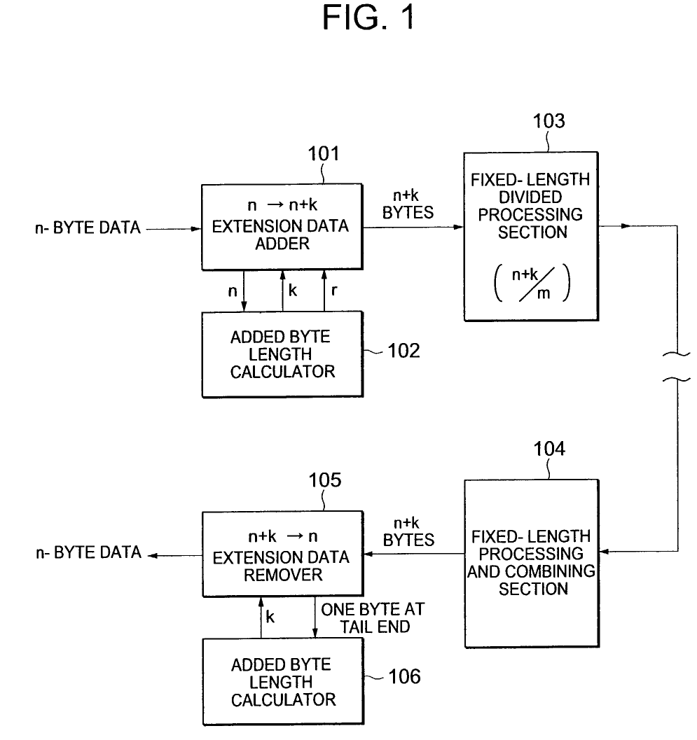

Referring to FIG. 1, a transmitting side includes an extension data adder 101, an added byte length calculator 102, and a fixed-length divided processing section 103 and a receiving side includes a fixed-length processing and combining section 104, an extension data remover 105, and an added byte length calculator 106. Here, it is assumed that variable-length data has a length of n bytes and the fixed-length divided processing section 103 is designed to process only data having the fixed length of m bytes, where n, m are natural numbers and 1<m<n.

When receiving variable-length data of n bytes, the extension data adder 101 extends the variable-length data so that the fixed-length divided processing section 103 can handle the extended variable-length data without any shortages or remainders. More specifically, the extension data adder 101 passes the data length n of the n-byte variable-length data to the added byte length calculator 102. The added byte length calculator 102 divides the variable-length n by the fixed-length m to calculate the number (r) of bytes of the remainder and a length (k) of bytes to be added and returns the calculated remainder r and the added byte length k to the extension data adder 101. More detailed description will be provided later.

The extension data adder 101 creates k-byte extension data including information indicative of the remainder r at a predetermined position thereof and adds it to the n-byte variable-length data at a predetermined position thereof to produce (n+k)-byte data, which is output to the fixed-length divided processing section 103. The k-byte extension data is preferably added to the tail end of the n-byte variable-length data. In this case, it is necessary to previously determine where the data indicative of the remainder r is away from the tail end of the n-byte variable-length data. Accordingly, the data indicative of the remainder r is preferably placed at the tail end of the n-byte variable-length data.

The fixed-length divided processing section 103 encrypts the (n+k)-byte data in units of m-byte fixed-length data. The data obtained by such processing is sent to the receiving side through, for example, a transmission line.

At the receiving side, the fixed-length processing and combining section 104 performs the processing of the received data by reversing the processing steps of the fixed-length divided processing section 103. More specifically, the received data is decrypted into a plurality of pieces of m-byte fixed-length data, which are combined into (n+k)-byte data. The (n+k)-byte data is output to the extension data remover 105.

The extension data remover 105 reads the remainder byte length r from the predetermined position of the (n+k)-byte data and passes it to the added byte length calculator 106. The added byte length calculator 106 calculates the added byte length k from the read remainder byte length r and returns it to the extension data remover 105. The extension data remover 105 removes k-byte extension data starting from the predetermined position of the (n+k)-byte data to produce the original n-byte variable-length data.

2. Creation and Addition of Extension Data

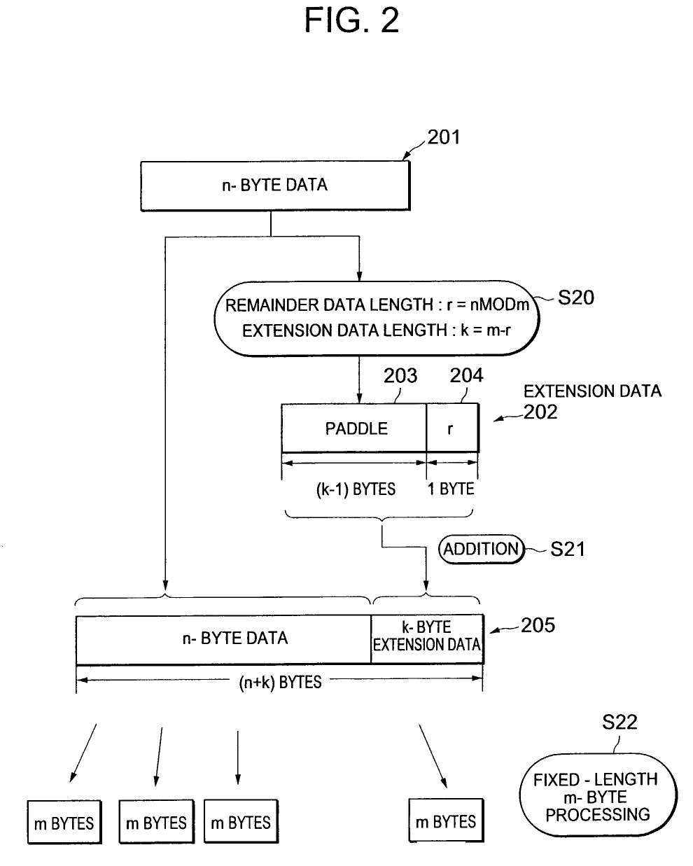

Referring to FIG. 2, when provided with the number (n) of bytes of n-byte variable-length data 201, the added byte length calculator 102 divides n by m to produce the remainder r(=nMODm) and then calculates an added byte length k by subtracting the remainder r from the fixed-length m predetermined in the fixed-length divided processing section 103 (step S20).

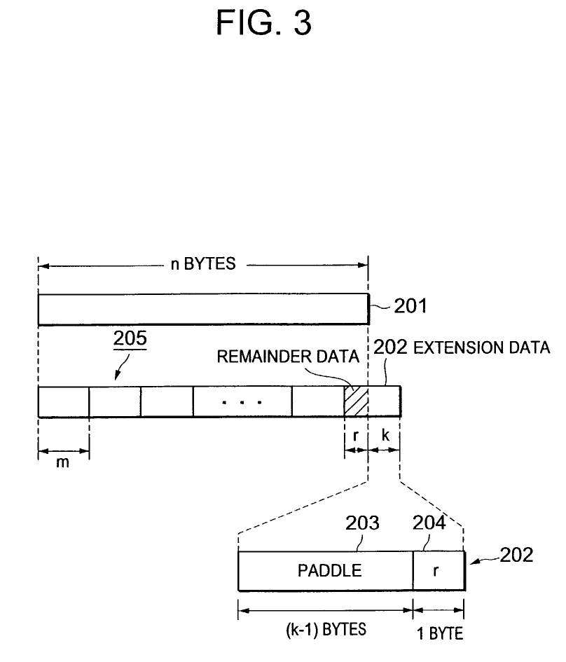

A relationship among the fixed length m, the remainder byte length r, and the added byte length k will be described with reference to FIG. 3. As described before, the fixed-length divided processing section 103 can accept only m-byte fixed-length data. Therefore, the n-byte variable-length data 201 is needed to be divided in units of the fixed length of m bytes. Since n is not always an integral multiple of m, there may be cases where the remainder r(0=<r<m) is left.

In order that the fixed-length divided processing section 103 can handle the r-byte remainder data as well, the k(=m−r)-byte extension data 202 is added to the n-byte data 201 at a predetermined position (here, the tail end) thereof, to produce the (n+k)-byte data 205 that can be divided by the fixed length m.

Since the extension data 202 is removed from the (n+k)-byte data 205 at the receiving side, reference data allowing calculation of the length of the extension data 202 is needed in the extension data 202. In this embodiment, the length (r) of the remainder is written as the reference data onto the k-byte extension data 202 at the predetermined position (here, the tail end) thereof.

For example, when the fixed length m falls into a range of 1<m<256, one byte is enough to represent the remainder length r because r<m and one byte can have any of 256 different values.

In this manner, the added byte length calculator 102 calculates the remainder data length r and the added byte length k and returns them to the extension data adder 101. As shown in FIG. 2, the extension data adder 101 creates the k-byte extension data 202 consisting of (k−1)-byte paddle 203 and one-byte reference data 204 and adds it to the n-byte data 201 at the predetermined position (here, the tail end) thereof to produce the (n+k)-byte data 205 (step S21).

The fixed-length divided processing section 103 receives the (n+k)-byte data 205 that can be divided by the fixed length m and performs fixed-length processing on (n+k)/m pieces of data having the fixed length of m bytes (step S22). Accordingly, the fixed-length processing of the variable-length data 201 is allowed by only adding a small amount of the extension data 202 to the variable-length data 201.

3. Removal of Extension Data

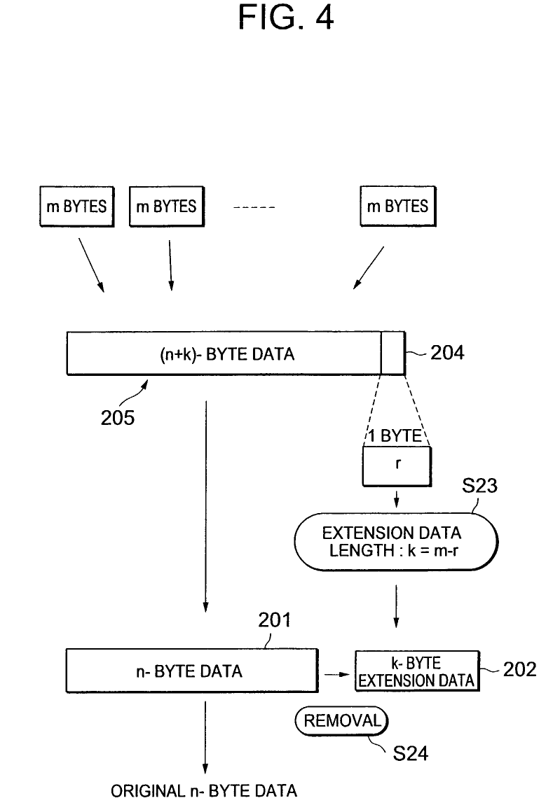

Referring to FIG. 4, the fixed-length processing and combining section 104 performs the processing of the received data by reversing the processing steps of the fixed-length divided processing section 103 to decrypt the received data into m-byte fixed-length data and combines the m-byte fixed-length data into the (n+k)-byte data 205. The (n+k)-byte data 205 is output to the extension data remover 105.

As described before, the remainder byte length r has been written as the reference data onto the predetermined position (here, the last one byte) of the (n+k)-byte data 205. Accordingly, the extension data remover 105 reads data from the last one-byte position of the (n+k)-byte data 205 and passes the read data, or the remainder byte length r, to the added byte length calculator 106. The added byte length calculator 106 calculates the added byte length k by subtracting the length r from the fixed length m, that is, k=m−r (step S23), and returns the added byte length k to the extension data remover 105.

The extension data remover 105 removes the last k bytes, that is, the extension data 202 of the (n+k)-byte data to produce the original n-byte data. In this manner, the original variable-length data can be readily reproduced from the output data of the fixed-length processing system.

4. Example

As an example to which the present invention is applied, a communication device will be described, which encrypts data to be transmitted and decrypts encrypted data according to the DES algorithm. In this case, the fixed-length divided processing section 103 of FIG. 1 corresponds to a DES encryption module and the fixed-length processing and combining section 104 of FIG. 1 corresponds to a DES decryption module. Such a communication device to which the present invention is applied may be an uplink port connecting between switching hubs or the like.

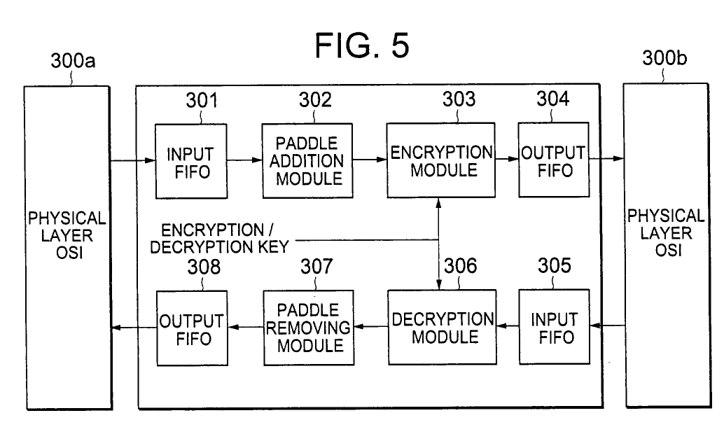

As shown in FIG. 5, n-byte variable-length data to be transmitted is generated by a data processing section (not shown) and is sequentially entered into a paddle addition module 302 via an input FIFO (First-In-First-Out) memory 301.

The paddle addition module 302 corresponds to a combination of the extension data adder 101 and the added byte calculator 102 shown in FIG. 1. The paddle addition module 302 adds the k-byte extension data to the n-byte transmission data to output the (n+k)-byte data to an encryption module 303.

The encryption module 303 divides the (n+k)-byte data in units of m-byte fixed-length data and performs encryption of each m-byte fixed-length data according to an encryption key. The encrypted (n+k)-byte data is transmitted to a physical layer (OSI) via an output FIFO memory 304.

Received data from a physical layer (OSI) is sequentially entered into a decryption module 306 via an input FIFO memory 305. The decryption module 306 decrypts the received data into m-byte fixed-length data according to the encryption key and combines the m-byte fixed-length data to output (n+k)-byte data to a paddle removing module 307.

The paddle removing module 307 corresponds to a combination of the extension data remover 105 and the added byte calculator 106 shown in FIG. 1. The paddle removing module 307 calculates the added byte length k from the last one-byte data of the (n+k)-byte data and removes k-byte data from the tail end of the (n+k)-byte data to produce n-byte variable-length data. The n-byte variable-length data is output to the data processing section via an output FIFO memory 308.

The input FIFO memory 301 is provided to absorb a phase difference between a transmission clock of the data processing section and a clock of the encryption/decryption modules. The output FIFO memory 304 is provided to absorb a phase difference between an Ethernet transmission clock and the clock of the encryption/decryption modules. Similarly, the input FIFO memory 305 is provided to absorb a phase difference between the Ethernet transmission clock and the clock of the encryption/decryption modules. The output FIFO memory 308 is provided to absorb a phase difference between a reception clock of the data processing section and the clock of the encryption/decryption modules.

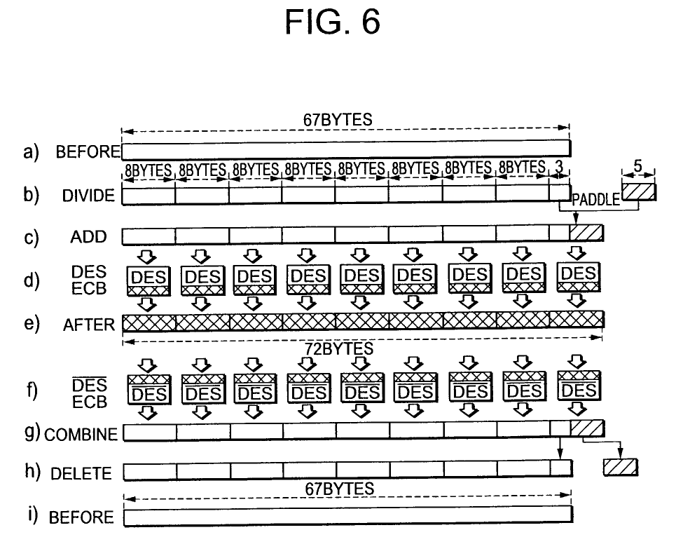

Referring to FIG. 6, a encryption/decryption processing flow is shown in the case where the fixed length m of the DES encryption module 303 is 8 (m=8), 0≦r<8, and 67-byte (n=67) variable-length data is transmitted and received.

In the case where 67-byte transmission data is given as shown in FIG. 6(a), since 67 divided by 8 yields a remainder of 3, r=3 and k=m−r=5 as shown in FIG. 6(b). Accordingly, 5-byte paddle data ‘0×0000000003’ having one-byte data indicative of r=3 at the tail end thereof is added to the 67-byte transmission data to produce extended transmission data of 72 bytes as shown in FIG. 6(c).

Subsequently, the 72-byte extended transmission data is divided into nine pieces of 8-byte data, each of which is encrypted in DES ECB mode as shown in FIG. 6(d) . In this manner, 72-byte encrypted data is obtained as shown in FIG. 6(e). Only addition of a small amount of paddle data allows variable-length data to be DES-encrypted.

On the other hand, when receiving such encrypted data, the DES decryption module 306 decrypts each 8-byte data thereof as shown in FIG. 6(f). The decrypted 8-byte data are combined into 72-byte data as shown in FIG. 6(g). The added paddle length k is calculated from the last one-byte data ‘0×03’ of the 72-byte data. Since k=8−3=5 bytes, the last 5-byte paddle data ‘0×0000000003’ is deleted from the 72-byte data as shown in FIG. 6(h). In this manner, the original 67-byte data is obtained as shown in FIG. 6(i), allowing easy reproduction of original variable-length data from DES-encrypted data.

The above embodiment has been described, taking the DES-encryption technique as an example. However, the present invention can be applied to not only such DES-encryption technique but also other data processing techniques that can accept only fixed-length data while inputting variable-length data.

The circuit components of the transmitting side as shown in FIG. 1, namely the extension data adder 101, the added byte length calculator 102, and the fixed-length divided processing section 103 maybe implemented by not only hardware but software. The circuit components of the receiving side as shown in FIG. 1, namely the fixed-length processing and combining section 104, the extension data remover 105, and the added byte length calculator 106 may be implemented by not only hardware but software. In other words, a program memory is provided to store a set of programs for instructing a computer to perform the creation, addition, and removal of the extended data as described before by referring to FIGS. 2-4. The same functions can be realized by running a program corresponding to each of the operations on the computer.

5. Media Converter

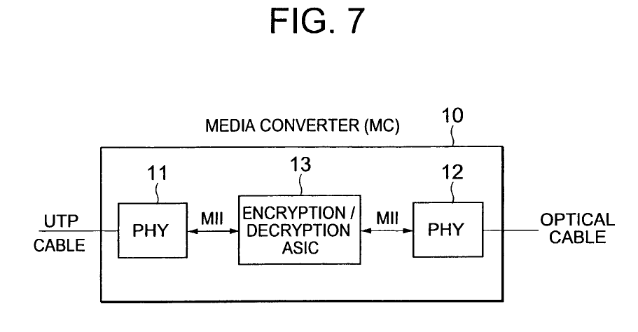

As shown in FIG. 7, a media converter (MC) 10 has a pair of ports, which are provided with physical-layer devices (PHYs) 11 and 12 connected to a UTP cable and an optical fiber cable, respectively. As described before, the physical-layer devices 11 and 12 support MII (Media Independent Interface) conforming to IEEE802.3 standards.

The media converter 10 is further provided with an encryption/decryption device 13 including a FIFO (First-in-first-out) memory. As described before, the encryption/decryption device 13 performs encryption of transmission data and decryption of reception data. The FIFO memory is used to absorb frequency deviations between transmission and reception. For example, variable-length data received at one physical-layer device are sequentially written into the FIFO memory and then read out from the FIFO memory in the same sequence. The read data is subjected to fixed-length encryption processing and the encrypted data is output to the other physical-layer device. On the other hand, encrypted data received at one physical-layer device are sequentially written into the FIFO memory and then read out from the FIFO memory in the same sequence to be decrypted. The decrypted data is output as variable-length data to the other physical-layer device.

The encryption/decryption device 13 may be implemented by Application specific Integrated Circuit (ASIC), which performs not only generation of encryption/decryption key but also the entire operation control of the media converter 10.

The media converter 10 of FIG. 7 has the circuit structure combining the transmitting side and the receiving side as shown in FIG. 1, provided that the fixed-length divided processing section 103 should be changed to an encryption processor and the fixed-length processing and combining section 104 should be changed to a decryption processor.

1. A data conversion method for fixed-length processing of variable-length data, comprising the steps of:
dividing a length of the variable-length data by a predetermined fixed length to produce a remainder data length;
subtracting the remainder data length from the predetermined fixed length to produce an added data length;
generating addition data including reference data that is used to determine the added data length; and
adding the addition data to the variable-length data to produce extended data that allows the fixed-length processing.

2. The data conversion method according to claim 1, wherein the reference data is placed at a tail end of the extended data.

3. The data conversion method according to claim 1, wherein the reference data is indicative of the remainder data length.

4. The data conversion method according to claim 1, wherein the fixed-length processing processes the extended data in units of the predetermined fixed length.

5. A data conversion method for use in a system composed of a transmitting side and a receiving side, comprising the steps of:
at the transmitting side,
dividing a length of the variable-length data by a predetermined fixed length to produce a remainder data length;
subtracting the remainder data length from the predetermined fixed length to produce an added data length;
generating addition data including reference data that is used to determine the added data length;
adding the addition data to the variable-length data to produce extended data having the reference data placed at a predetermined position of the extended data; and
performing the fixed-length processing of the extended data to produce transmission data to be transmit to the receiving side,
at the receiving side,
receiving the transmission data from the transmitting side;
performing reversed fixed-length processing of the received transmission data by reversing the fixed-length processing of the extended data to produce reception data;
reading the reference data from the predetermined position of the reception data to determine the added data length; and
removing data corresponding to the added data length from the reception data to reproduce original variable-length data.

6. The data conversion method according to claim 5, wherein the fixed-length processing is encryption processing and the reversed fixed-length processing is decryption processing corresponding to the encryption processing.

7. A data conversion apparatus for fixed-length processing of variable-length data, comprising:
a calculator for dividing a length of the variable-length data by a predetermined fixed length to produce a remainder data length and subtracting the remainder data length from the predetermined fixed length to produce an added data length;
a data adder for generating addition data including reference data that is used to determine the added data length and adding the addition data to the variable-length data to produce extended data; and
a fixed-length processor for processing the extended data.

8. The data conversion apparatus according to claim 7, wherein the fixed-length processor is an encryption processor that encrypts the extended data in units of the predetermined fixed length.

9. A data conversion apparatus comprising:
a fixed-length processor for performing fixed-length processing of input data to produce first data;
a calculator for reading reference data from a predetermined position of the first data to determine an added data length; and
an added data remover for removing data corresponding to the added data length from the first data to reproduce original variable-length data.

10. The data conversion apparatus according to claim 9, wherein the fixed-length processor is a decryption processor that decrypts the input data in units of the predetermined fixed length to produce the first data.

11. A data conversion program instructing a computer to perform m-byte fixed-length processing of n-byte variable-length data, where n is a natural number and 0<m<n, the program comprising the steps of:
calculating a remainder r by dividing n by m;
subtracting the remainder r from a fixed length m to determine an added data length k;
generating addition data including reference data indicative of the remainder r that is used to determine the added data length k;
adding the addition data to the variable-length data to produce (n+k)-byte extended data; and
performing the m-byte fixed-length processing of the(n+k)-byte extended data.

12. A data conversion program instructing a computer to perform m-byte fixed-length processing of n-byte variable-length data, where n is a natural number and 0<m<n, the program comprising the steps of:
in a transmission section,
calculating a remainder r by dividing n by m;
subtracting the remainder r from a fixed length m to determine an added data length k;
generating addition data including reference data indicative of the remainder r that is used to determine the added data length k;
adding the addition data to the variable-length data to produce (n+k)-byte extended data; and
performing the m-byte fixed-length processing of the (n+k)-byte extended data to produce transmission data;
transmitting the transmission data,
in a reception section,
performing m-byte reversed fixed-length processing of received data by reversing the m-byte fixed-length processing of (n+k)-byte extended data to produce reception data;
reading the reference data from the predetermined position of the reception data to determine an added data length; and
removing data corresponding to the added data length from the reception data to reproduce original variable-length data.

13. A media converter for converting from one type of transmission media to another, comprising:
a first physical-layer interface to a first transmission medium;
a second physical-layer interface to a second transmission medium; and
an encryption section connected between the first and second physical-layer interfaces, for converting variable-length data received from the first physical-layer interface into fixed-length data of a predetermined fixed length to encrypt it and output encrypted data to the second physical-layer interface,
wherein the encryption section comprises:
a calculator for dividing a length of the variable-length data by the predetermined fixed length to produce a remainder data length and subtracting the remainder data length from the predetermined fixed length to produce an added data length;
a data adder for generating addition data including reference data that is used to determine the added data length and adding the addition data to the variable-length data to produce extended data allowing encryption processing, wherein the reference data is placed at a predetermined position of addition data; and
an encryption processor for encrypting the extended data to produce the encrypted data.

14. The media converter according to claim 13, further comprising:
a decryption section connected between the first and second physical-layer interfaces, for decrypting encrypted data received from the second physical-layer interface to produce variable-length data to output it to the first physical-layer interface,
wherein the decryption section comprises:
a decryption processor for decrypting the encrypted data to produce reception data;
a calculator for reading reference data from the predetermined position of the reception data to determine an added data length; and
an added data remover for removing data corresponding to the added data length from the reception data to reproduce original variable-length data.

15. The media converter according to claim 13, wherein the data adder places the reference data at a tail end of the extended data.

16. An encryption method in a media converter for converting from one type of transmission media to another, comprising the steps of:
dividing a length of the variable-length data by a predetermined fixed length to produce a remainder data length;
subtracting the remainder data length from the predetermined fixed length to produce an added data length;
generating addition data including reference data that is used to determine the added data length;
adding the addition data to the variable-length data to produce extended data that allows the fixed-length processing; and
encrypting the extended data in units of the predetermined fixed length.

17. The encryption method according to claim 16, wherein the reference data is placed at a tail end of the extended data.

18. The encryption method according to claim 16, wherein the reference data is indicative of the remainder data length.

19. A decryption method for decrypting encrypted data produced by the encryption method according to claim 16, comprising the steps of:
receiving the encrypted data;
decrypting the encrypted data to produce reception data;
reading the reference data from the predetermined position of the reception data to determine the added data length; and
removing data corresponding to the added data length from the reception data to reproduce original variable-length data.
